(19) United States
(12) Patent Application Publication
(10) Pub. No.: US 2026/0151717 A1
(43) Pub. Date: Jun. 4, 2026

(54) BIOCHAR MATERIALS FOR ABATEMENT OF POLLUTANTS

(71) Applicant: AbTech Industries, Inc., Scottsdale, AZ (US)

(72) Inventor: Narghis Sarwari, Glendale, AZ (US)

(73) Assignee: AbTech Industries, Inc., Scottsdale, AZ (US)

(21) Appl. No.: 18/966,110

(22) Filed: Dec. 2, 2024

(51) Int. Cl. B01D 24/00; B01D 39/04; C02F 1/00; C02F 101/32; C02F 101/36

(52) U.S. Cl. CPC B01D 24/001; B01D 39/04; C02F 1/001; B01D 2101/00; B01D 2239/0283; B01D 2239/1241; B01D 2239/1291; C02F 2101/32; C02F 2101/36

(57) ABSTRACT

Material compositions usable for abatement of various pollutants include particles of modified biochar material that are adhered to styrene-butadiene-styrene granules embedded in an M-Class rubber material. A modified biochar material is formed by additional heating of conventional biomass-based biochar. Also disclosed are (i) methods of synthesis of the modified biochar material, (ii) methods of synthesis of compositions that include the modified biochar material, (ii) products, including filter devices, that use such compositions, and (iii) methods employing those products for removing pollutants from a water stream.

### TECHNICAL FIELD

The present disclosure relates to materials and products for reduction or removal (i.e., abatement) of pollutants of the environment. In particular, disclosed biochar materials, methods for their formation, compositions incorporating them, and apparatus and methods for their use can abate various pollutants, e.g., hydrocarbons, metals or metal oxides, or per-or polyfluorinated alkyl substances (PFASs, i.e., so-called forever chemicals).

### BACKGROUND

Co-owned U.S. Pat. No. 6,723,791 (“Systems for ameliorating aqueous hydrocarbon spills” by Rink et al; hereinafter referred to as the '791 patent) discloses compositions that are effective for absorbing hydrocarbon pollutants from water while facilitating relatively low-resistance flow of the water through the material. In some examples the absorbent material comprises styrene-butadiene-styrene (SBS) granules embedded in an M-Class rubber (MCR) material, e.g., an ethylene propylene diene monomer (EPDM) material. The '791 patent discloses synthesis and use of the disclosed compositions. The '791 patent is incorporated herein by reference in its entirety.

Co-owned U.S. Pat. No. 11,124,432 (“Compositions, articles, and methods for abatement of hydrocarbon, metals, and organic pollutants” issued to Lolling et al; hereinafter referred to as the '432 patent) discloses modifications of or additions to the compositions of the '791 patent for abatement of other pollutants in addition to hydrocarbons, e.g., metals, metal oxides, phosphates, or PFASs. In various examples disclosed in the '432 patent, one or more of activated carbon, biochar, wood chips or dust, nanoparticles, can be combined with the absorbent material of the '791 patent. Those additional components act to remove various additional pollutants from the water stream. The '432 patent also discloses methods for incorporating the additional components into the hydrocarbon-absorbent material of the '791 patent without spoiling its capacity for absorbing hydrocarbons or its low resistance to water flow therethrough. The '432 patent is incorporated herein by reference in its entirety.

### SUMMARY

A method for modifying a conventional starting biochar material includes multiple heating steps under non-oxidizing conditions followed by rapid cooling under non-oxidizing conditions. The starting biochar material can be derived from suitable biomass (e.g., manure of any type, poultry litter, hemp stalk, mushrooms, or waste animal bones), using any suitable conventional biochar process. The modified biochar material exhibits electrical conductivity greater than 4 dS/m and a molar H/C ratio less than 0.40. The modified biochar material exhibits greater affinity for PFASs than does the starting biochar material.

In a first example the starting biochar material is heated to between 400° C. and 500° C. for between 100 and 140 minutes within a CO₂ atmosphere, then heated to between 800° C. and 1000° C. for between 50 and 70 minutes within a CO₂ atmosphere, and then rapidly cooled within an atmosphere of N₂ or noble gas, yielding a modified biochar material.

In a second example the starting biochar material is heated to between 400° C. and 500° C. within a CO₂ atmosphere for between 50 and 70 minutes, then heated to between 600° C. and 700° C. within a N₂ atmosphere for between 50 and 70 minutes, then heated to between 800° C. and 1000° C. within a ₂ atmosphere for between 50 and 70 minutes, and then rapidly cooled within an atmosphere of N₂ or noble gas, yielding a modified biochar material.

A composition of matter includes particles of modified biochar material attached to styrene-butadiene-styrene (SBS) granules embedded in an M-Class rubber (MCR) material. In some examples the particles of the modified biochar material can be present at a proportion of between 20 and 28 percent of total weight of modified biochar material, the SBS granules, and MCR material. In some examples the MCR material can be an ethylene propylene diene monomer (EPDM) material.

The composition of matter can be made by (i) mixing particles of the modified biochar material, the SBS granules, and MCR granules, (ii) feeding the mixture through an extruder, (iii) heating the mixture in the extruder, and (iv) extruding the heated mixture through a die. The mixture can be cut as it passes out of the die to form fractured fragments.

Those fragments can be used to form a filter device wherein an influent water stream is directed into an inlet, flows through interstices of a multitude of the fractured fragments, and exits through a discharge outlet as an effluent water stream. PFAS concentration of an effluent water stream can be less than 2% of PFAS concentration of an influent water stream (i.e., the composition of matter can remove more than 98% of the PFASs originally present in the influent water stream).

Objects and advantages pertaining to biochar materials and their use for abatement of pollutants may become apparent upon referring to the example embodiments illustrated in the drawings and disclosed in the following written description.

This Summary is provided to introduce a selection of aspects in a simplified form that are further described below in the Detailed Description. This Summary is not intended to identify key features or essential features of the claimed subject matter, nor is it intended to be used as an aid in determining the scope of the protected subject matter.

### BRIEF DESCRIPTION OF THE DRAWINGS

FIG. 1 tabulates various known methods for producing conventional biochar material, such as from manure (from: Cheng et al; “Application Research of Biochar for the Remediation of Soil Heavy Metals Contamination: A Review”; Molecules 25(14) 3167(2020 ); https://doi.org/10.3390/molecules25143167).

FIG. 2 is a flow chart representing a first example method for modifying biochar material according to the present disclosure.

FIG. 3 is a flow chart representing a second example method for modifying biochar material according to the present disclosure.

FIG. 4 is an enlarged portion of a fragment including modified biochar particles, SBS granules, and an MCR material.

FIG. 5 is an outline of a fragment, of which FIG. 4 shows enlarged details.

FIG. 6 is a flow chart representing an example method for forming copolymer fragments.

FIG. 7 depicts (in cut-away view) an example filtration module that includes a filter cartridge containing a multitude of copolymer fragments formed according to various aspects of the present disclosure.

FIG. 8 depicts (in cut-away view) an example open-topped filter device containing a multitude of copolymer fragments formed according to various aspects of the present disclosure.

FIG. 9 tabulates concentrations of various PFASs before and after filtration for several water samples using example filtration media incorporating modified biochar materials.

FIG. 10 tabulates concentrations of various PFASs before and after filtration for several water samples using example filtration media incorporating modified biochar materials.

FIG. 11 illustrates schematically an example reaction chamber that can be employed for producing modified biochar material.

The embodiments depicted are shown only schematically; all features may not be shown in full detail or in proper proportion; for clarity certain features or structures may be exaggerated or diminished relative to others or omitted entirely; the drawings should not be regarded as being to scale unless explicitly indicated as being to scale. The embodiments shown in the figures are only examples and should not be construed as limiting the scope of the present disclosure or the inventive subject matter.

### DETAILED DESCRIPTION

The following detailed description should be read with reference to the drawings, in which identical reference numbers refer to like elements throughout the different figures. The detailed description illustrates by way of example, not by way of limitation, the principles of disclosed or inventive subject matter.

The '791 and '432 patents discussed in the background disclose compositions and their use for removal from a water stream of hydrocarbon pollutants along with a variety of other pollutants, such as metals, metal oxides, phosphates, or PFASs. However, improvements of the effectiveness of removing PFASs from water remain desirable. In some instances, those previous compositions remove less than 40% of the PFASs present in a water stream. Per-and polyfluoroalkyl substances (PFASs) are a group of chemicals, used in many products, and are also known as “forever chemicals,” because they are very persistent in the environment and in the bodies of humans and animals. They can build up in living things and can have adverse effects on human health and the environment, so they are increasingly recognized as significant pollutants. New and better methods are being sought for their removal from the environment, including from water supplies or wastewater. It would be desirable to develop improved compositions, beyond those disclosed in the '791 or '432 patent, that exhibit increased affinity for PFASs and that enable higher levels of removal of PFASs from a water stream.

Accordingly, disclosed herein are methods of modifying conventional biochar material, and processes of forming such materials, to increase affinity of such materials for PFASs, as well as methods of incorporating such modified biochar material into modified filtration compositions (such as those disclosed in the '971 and '432 patents), and methods using modified filtration compositions to remove larger fractions of PFASs from water streams compared to previously disclosed compositions.

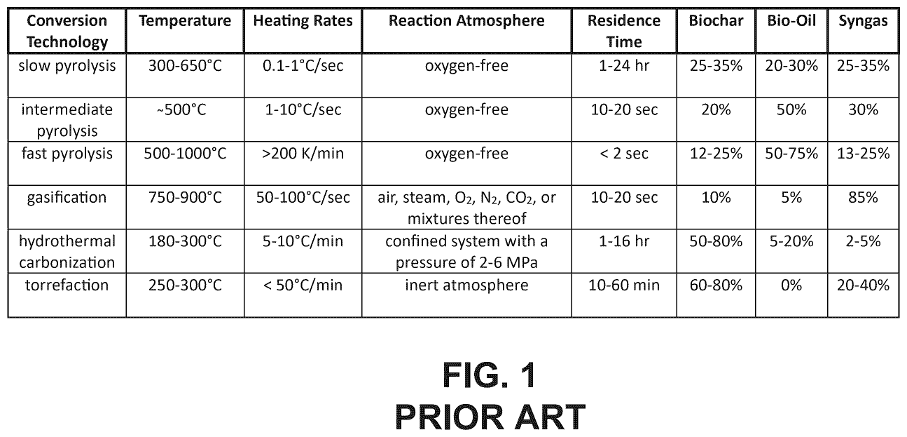

Conventional biochar material, e.g., derived from any suitable plant-or animal-based biomass starting material (e.g., manure of any type, poultry litter, hemp stalk, mushrooms, waste animal bones, and so forth) by any suitable process (e.g., see the table of FIG. 1 from Cheng et al) can be employed as a starting biochar material. The starting biochar material can be formed by, e.g., slow pyrolysis, intermediate pyrolysis, fast pyrolysis, gasification, hydrothermal carbonization, or torrefaction. In some examples the processing used to produce the starting biochar material can be combined with the biochar modification process described herein to form a single, integrated overall process flow. In other examples the starting biochar material can be produced by a separate process flow, or can be obtained from an external source or producer and then modified. Whatever its source or manner of production, the starting biochar material can be modified according to aspects of the present disclosure to produce a modified biochar material having a greater affinity for PFASs compared to the starting biochar material.

Regardless of the source or manner of production of the starting biochar material, it can be modified and used according to the present disclosure. Generally, a method for modifying the starting biochar material includes multiple heating steps, each within a corresponding non-oxidizing atmosphere, at a first elevated temperature and then at one or more higher elevated temperatures, followed by rapid cooling within a non-oxidizing atmosphere.

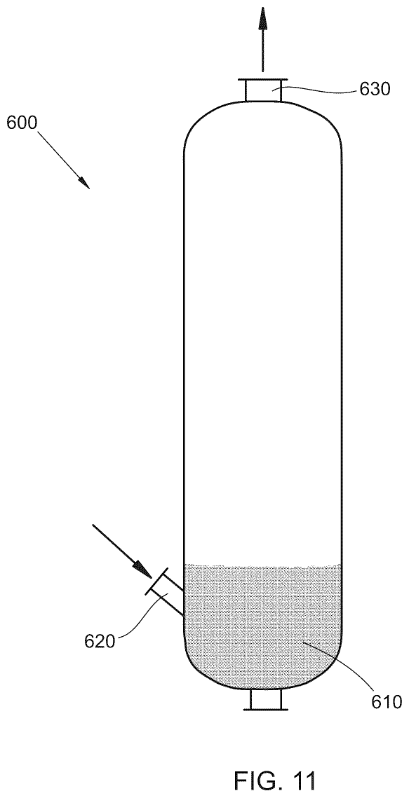

Each non-oxidizing atmosphere has no molecular oxygen or other oxidizing gaseous material, or only negligible amounts of such materials. The non-oxidizing atmosphere typically flows through the biochar material during the modification processes described herein (e.g., into a reaction chamber 600 through a gas inlet port 620, through biochar material 610 in chamber 600, and out through a gas outlet port 630; see FIG. 11). A suitable non-oxidizing atmosphere can include, e.g., molecular nitrogen, carbon dioxide, one or more noble gases, or mixtures thereof.

The example reaction vessel 600 illustrated schematically in FIG. 11 is arranged in a manner similar to a gasifier. In some examples biochar material 610 (e.g., the starting biochar material before the modification process, the intermediate biochar material during the modification process, or the modified biochar material at the end of the modification process) can form a fluidized bed in the reaction vessel 600 as each non-oxidizing atmosphere flows through the biochar material. Other suitable reaction vessel can be employed with any suitable arrangement of the biochar material therein and any suitable arrangement for introducing the non-oxidizing atmosphere(s).

The corresponding non-oxidizing atmosphere for each heating or cooling step (i.e., the composition of the non-oxidizing atmosphere) can be the same for all the heating and cooling steps, or can differ between or among two or more or all of the heating and cooling steps. The corresponding elevated temperatures can differ between or among all of the heating steps, or can be the same for some of the heating steps. Two heating steps can differ with respect to temperature, the type of non-oxidizing atmosphere, or both; two consecutive heating steps having the same temperature and non-oxidizing atmosphere can be considered as effectively forming a single heating step. Typically, the various heating or cooling steps are all conducted in the same reaction chamber or vessel one after another (i.e., without allowing the biochar material in the reaction vessel to cool between steps), but separate reaction chambers or vessels can be used if needed or desired.

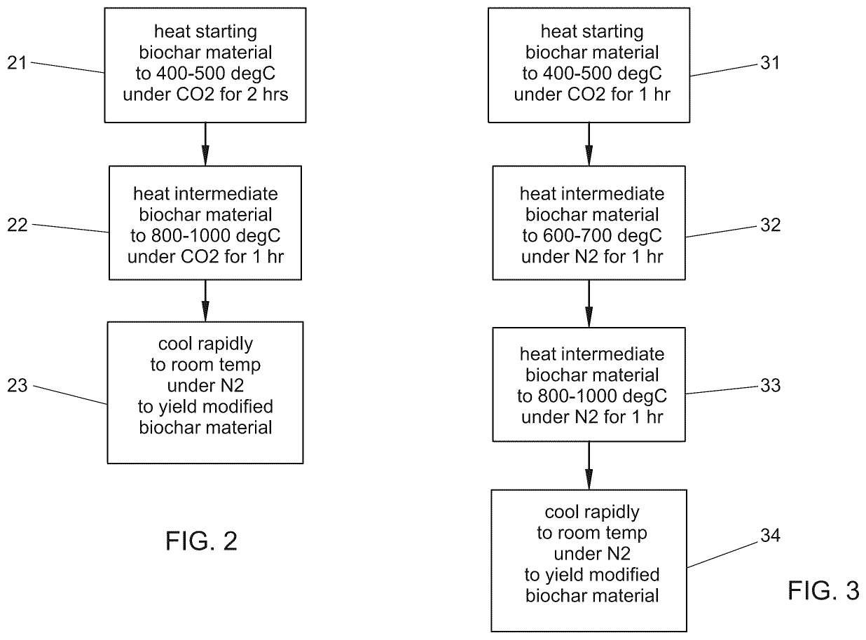

In a first example (e.g., as in FIG. 2), the starting biochar material is first heated (see box 21 of FIG. 2) in a CO₂ atmosphere to a first elevated temperature between 400° C. and 500° C., between 425° C. and 475° C., or at about 450° C. The CO 2 atmosphere and the first elevated temperature are maintained for about two hours (e.g., between 100 and 140 minutes, between 110 and 130 minutes, or 120 minutes) to form an intermediate biochar material. In some examples the starting biochar material can be heated to the first elevated temperature at a rate of heating between 15° C./min and 25° C./min, between 18° C./min and 22° C./min, or at about 20° C./min. Next, the intermediate biochar material is heated (see box 22) to a second elevated temperature between 750° C. and 1000° C., between 850° C. and 950° C., or at about 900° C. in the CO 2 atmosphere and maintained at that elevated temperature for about one hour (e.g., between 50 and 70 minutes, between 55 and 65 minutes, or 60 minutes). Again, in some examples the rate of heating can be between 15° C./min and 25° C./min, between 18° C./min and 22° C./min, or at about 20° C./min. Afterwards, the intermediate biochar material is cooled (see box 23) in an atmosphere of N₂ or a noble gas to room temperature at a rate of cooling greater (i.e., faster) than the rates of heating (comparing absolute values), and in some examples as rapidly as is practicable (based on, e.g., equipment capability or cost). In some examples the intermediate biochar material is cooled to room temperature in less than 30 minutes, or less than 15 minutes. The cooling rate can depend on, e.g., size of the reaction chamber or vessel, the mass of the intermediate biochar material being cooled, or the flow rate of gases through the reaction volume. This first example process forms a first example modified biochar material.

In a second example (e.g., as in FIG. 3), the starting biochar material is heated (see box 31 of FIG. 3) in a CO₂ atmosphere to a first elevated temperature between 400° C. and 500° C., between 425° C. and 475° C., or at about 450° C. The CO₂ atmosphere and the first elevated temperature are maintained for about one hour (e.g., between 50 and 70 minutes, between 55 and 65 minutes, or 60 minutes) to form an intermediate biochar material. In some examples the starting biochar material can be heated to the first elevated temperature at a rate of heating between 15° C./min and 25° C./min, between 18° C./min and 22° C./min, or about 20° C./min. Next, the intermediate biochar material is heated (see box 32) to a second elevated temperature between 600° C. and 700° C., between 625° C. and 675° C., or at about 650° C. in a N₂ atmosphere and maintained at that second elevated temperature for about one hour (e.g., between 50 and 70 minutes, between 55 and 65 minutes, or 60 minutes). In some examples the rate of heating can be between 15° C./min and 25° C./min, between 18° C./min and 22° C./min, or about 20° C./min. Next, the intermediate biochar material is heated (see box 33) to a third elevated temperature between 750° C. and 1000° C., between 850° C. and 950° C., or at 900° C. in the N₂ atmosphere and maintained at that third elevated temperature for about one hour (e.g., between 50 and 70 minutes, between 55 and 65 minutes, or 60 minutes). In some examples the rate of heating can be between 15° C./min and 25° C./min, between 18° C./min and 22° C./min, or about 20° C./min. Afterwards, the intermediate biochar material is cooled (see box 34) in an atmosphere of N₂ or a noble gas to room temperature at a rate of cooling greater (i.e., faster) than the rates of heating (comparing absolute values), or as rapidly as is practicable (e.g., in less than 30 minutes or less than 15 minutes). This second example process forms a second example modified biochar material.

The modified biochar material, including material produced by either of the example processes discussed above, exhibits electrical conductivity greater than 4 dS/m and a molar H/C ratio less than 0.4. This is in contrast to the starting biochar material, which typically exhibits lower electrical conductivity (e.g., less than 3 dS/m in some examples) or a higher H/C ratio (e.g., greater than 0.45 in some examples) than the modified biochar material. A combination of higher electrical conductivity and lower H/C ratio appears to be correlated with increased affinity for PFASs exhibited by the example modified biochar material, relative to various starting biochar materials. In some examples the modified biochar material can exhibit electrical conductivity greater than 5 dS/m or a molar H/C ratio less than 0.35; in some examples the modified biochar material can exhibit electrical conductivity greater than 6 dS/m or a molar H/C ratio less than 0.30.

Whichever process is employed to produce the modified biochar material (including those disclosed above), the modified biochar material can be incorporated into suitable compositions, materials, or devices. In particular, the modified biochar material can be advantageously employed where increased affinity for PFASs is desirable for abatement of those substances from a water stream.

In some examples in which water filtration is desired, a composition of matter can be employed that comprises particles of the modified biochar material attached to styrene-butadiene-styrene (SBS) granules embedded in an M-Class rubber (MCR) material. Such compositions of matter can exhibit increased PFAS filtration capability compared to compositions disclosed in the '432, due to the increased affinity of the modified biochar material for PFASs.

In some examples a composition comprising the modified biochar material, SBS granules, and MCR material can be formed into a solid body capable of removing hydrocarbons and PFASs entrained in a volume of water flowing therethrough. In some examples that material can remove more than 80% of PFASs present in the influent water stream, more than 90%, more than 95%, more than 98%, or more than 99%. In some examples that material has also been observed to remove over 80% of certain metals present in the influent water stream, e.g., iron, aluminum, copper, manganese, and zinc.

In some examples an SBS/MCR material combined with the modified biochar can include one or more additional materials, e.g., activated carbon, conventional biochar, another type of modified biochar, wood chips or dust, or nanoparticles). In such situations, the SBS/MCR material can act as a carrier for those additional materials, and the resulting solid body can be used to remove other pollutants (e.g., one or more metals, one or more metal oxides, or one or more phosphates) as well as PFASs and hydrocarbon materials.

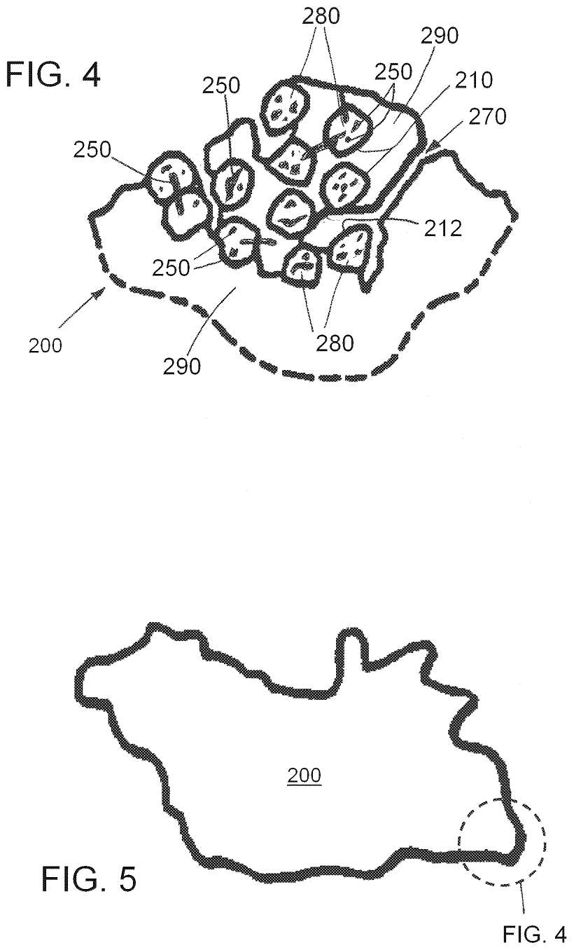

FIGS. 4 and 5 illustrate examples of a suitable solid body or fragment 200, which can be used as a solid body containing the modified biochar material formed according to this disclosure; a multitude of fragments 200 can be formed and used in a filter or agglomerated into a larger solid body. FIG. 4 shows a close-up view of the indicated portion of fragment 200 shown in FIG. 5. FIG. 5 shows a macroscopic fragment 200 with an average diameter of approximately 1-2 cm, although because of the irregular shape, the diameter varies between fragments and on different lines across a single fragment. As seen in FIG. 4, fragment 200 can include an M-Class rubber (MCR) material 290 that forms a durable but permeable structure for SBS granules 280 and that provides mechanical integrity to fragment 200. Surfaces of the SBS granules (e.g., surface 210 of granules embedded in the MCR or exposed surface 212 in interstices 270), and preferably also MCR material 290 itself, can include particles 250 of the modified biochar material. Alternatively, in embodiments without SBS, particles 250 of the modified biochar material can be embedded in an MCR material 290. Any of the resulting compositions can achieve multi-functional decontamination capability, by allowing abatement of PFASs (by the modified biochar material) and hydrocarbon pollutants (by the SBS/MCR materials). Simultaneous abatement of one or more other pollutants also can be achieved, if additional suitable material(s) are incorporated into fragments 200).

As used herein, an “M-Class rubber” (MCR) is a rubber as defined in ASTM Standard D-1418 of ASTM International, “Standard Practice for Rubber and Rubber Lattices—Nomenclature.” This standard defines the M-Class as rubbers having a saturated chain of the polyethylene type. Exemplary M-Class rubbers as set forth in the standard include ACM, AEM, ANM, BIMSM, CM, CFM, CSM, EOM, EPDM, EPM, EVM, FEPM, FFKM, FKM, Type 1, Type 2, Type 3, Type 4, and Type 5 rubbers. Any suitable MCR can be employed; details of certain suitable MCRs are disclosed in the '791 and '432 patents.

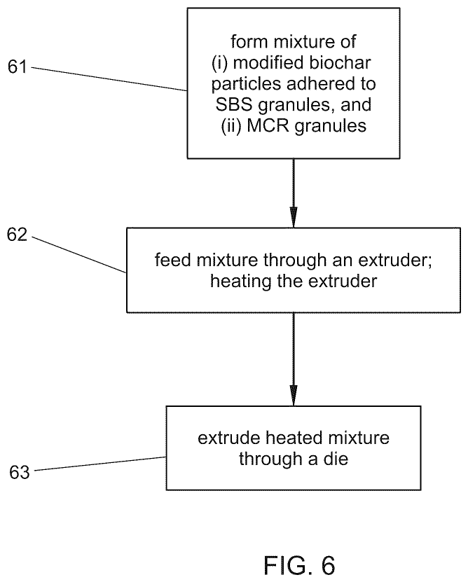

Fragments 200 (i.e., copolymer fragments) can be formed, for example, according to processes such as the example process shown in FIG. 6. First, particles 250 of the modified biochar material, styrene-butadiene-styrene (SBS) granules 280, and M-Class rubber (MCR) granules 290 are mixed (all three materials together at once, or one material added to a premix of the other two; see box 61 of FIG. 6) to form a mixture of (i) particles 250 of the modified biochar material attached to SBS granules 280 and (ii) granules of the MCR 290. In some examples the mixture can be formed at a temperature of at least 95° F. (35° C.), at which temperature SBS granules 280 expand without melting and particles 250 of the modified biochar are adhered to SBS granules 280. The mixture is then fed through an extruder (see box 62), while heating the mixture in the extruder. Then the heated mixture is extruded through a die (see box 63). Particles 250 of the modified biochar material can be present at a proportion of between 20 and 28 percent of total weight of the mixture of modified biochar material, SBS granules, and MCR material. In some examples MCR material 290 is an ethylene propylene diene monomer (EPDM) material. The mixture can be cut automatically as it passes out of the die to form fragments 200.

Any suitable extrusion process can be employed; details of certain suitable extrusion processes are disclosed in the '791 and '432 patents. In some examples the mixture in the extruder can be heated to a temperature that is greater than 15° F. (8° C.) below an effective melting point of the MCR at the pressure in the extruder and less than 10° F. (6° C.) above the effective melting point of the MCR at the pressure in the extruder, and also less than an effective melting point of the SBS at the pressure in the extruder. In some examples the mixture in the extruder can be heated by setting the extruder to a temperature of between 49° C. and 54° C. In some examples the fragments 200 can be between 1 and 2 centimeters in diameter (or largest dimension).

In some examples fragments 200 may be packaged into pouches, bags, sleeves, and other flexible containers, and such containers can be used as floating skimmer or floating boom products that are deployable on water surfaces. Examples of floating skimmer and boom products that may contain such fragments are disclosed in the '791 patent.

In some examples fragments 200 can be loaded into filter devices, e.g., into filter housings or other flow-through liquid-separation devices, including housings or devices intended to be retrofit into existing infrastructure. Such filter devices can include a multitude of fragments 200 supported between an inlet for influent water flow and a discharge outlet for effluent water flow. In some examples fragments 200 can be deployed in a pipe or in a filtration cartridge. An influent water stream is directed to flow into an inlet, through interstices of the multitude of fractured fragments 200, and out of a discharge outlet as an effluent water stream. The inlet or discharge outlet can be of any suitable type, structure, or arrangement, e.g., a pipe, valve, port, spigot, trough, gutter, or other entry point, intake point, exit point, or discharge point. The inlet and discharge outlet can be of the same type or can differ with respect to type, structure, or arrangement thereof.

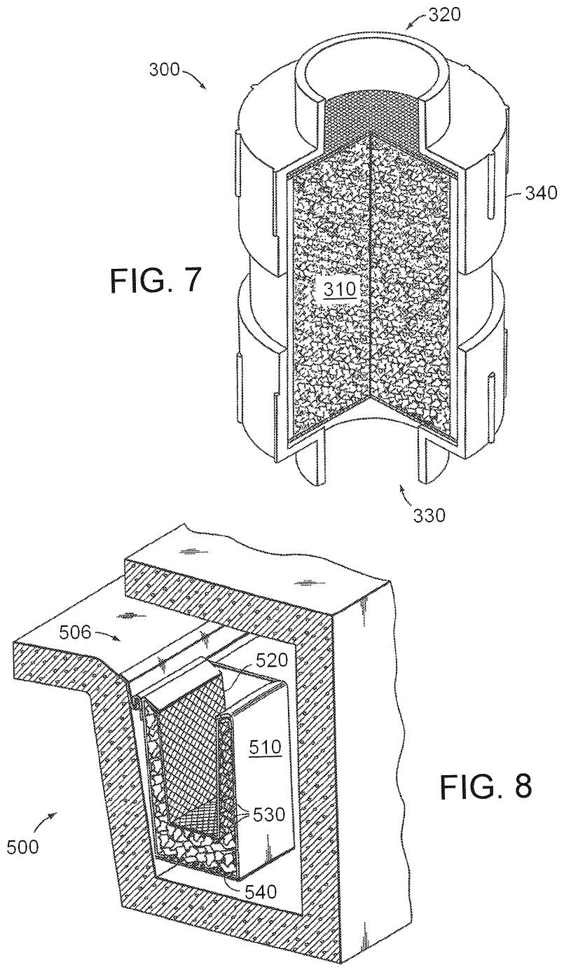

An example filter module is shown in FIG. 7, in which filter module 300 includes a cartridge 340 having inlet 320 and discharge outlet 330, shown in this example as being at opposite ends. In some examples the filter module can be reversible, i.e., inlet 320 and discharge outlet 330 can be interchanged. Cartridge 340 can be packed with a multitude of fragments 310 produced as described above and shown in FIGS. 4 and 5.

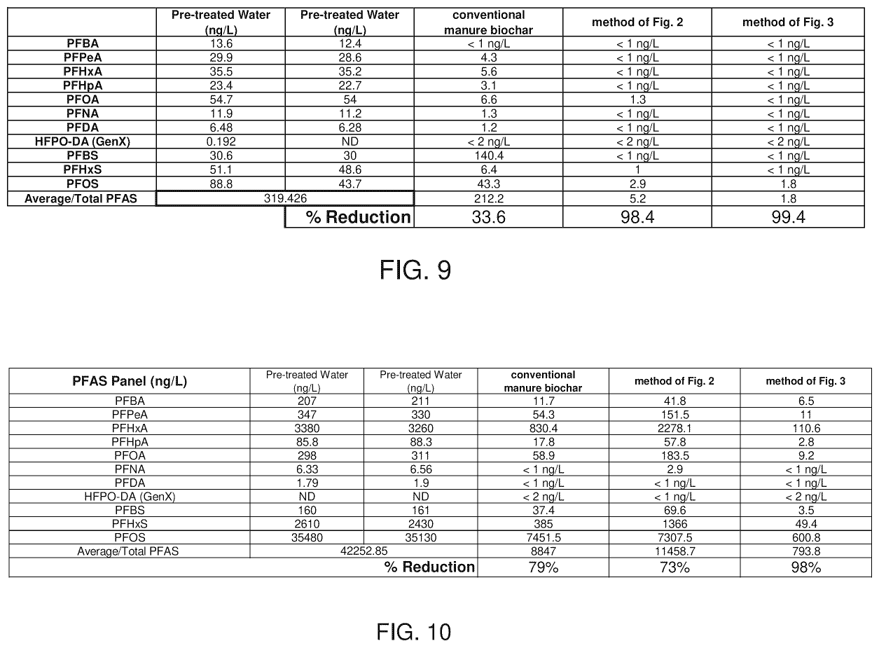

In some examples the fragments may be disposed in an open-topped recess within a filter module of a filter device. An example filter device with this structure is shown in FIG. 8. Filter device 500 includes a hopper 510 containing a basket 520 (such as of a wire mesh material) forming a recess with an open top. A multitude of fragments 530 (produced as described above and shown in FIGS. 4 and 5) are contained in the space between hopper 510 and basket 520. Hopper 510 may be configured, for example, to be suspended in a storm drain adjacent to a curb inlet, such as on a bracket. In use, runoff water (not shown) enters a curb-inlet 506 of a storm drain and passes into filter device 500 as an influent water stream. After entering hopper 510, the water passes through the mesh screen of basket 520, which traps trash items, and into and through the multitude of fragments 530 and through interstices of the multitude. Accordingly, hydrocarbon and PFAS pollutants (and one or more other pollutants, if additional suitable material(s) are incorporated into fragments 530) are reduced in or removed from the runoff water, and the overall purity of the water passing out of hopper 510 as an effluent water stream (through perforated steel or plastic bottom 540) is improved.

Improved efficacy for removing PFASs from a stream of water, of fragments 200 that include the modified biochar material produced as described in connection with FIGS. 2 and 3 above, is illustrated in tables shown in FIGS. 9 and 10. The tabulated data compare PFAS removal by a multitude of fragments 200 that incorporate either (i) manure-based biochar without further modification (as is conventionally used), (ii) manure-based biochar modified according to the method of FIG. 2, or (iii) manure-based biochar modified according to the method of FIG. 3.

FIG. 9 contains data produced from measurements of experimental treatment of several water samples with a total PFAS load that is initially less than 1 mg/L (around 300 ng/L in the specific examples shown). Filtration media that include either of the example modified biochar materials left less than 2% of the original PFAS concentration in the filtered effluent water, while conventional biochar filtration media left more than 60% of the original PFAS concentration in the filtered effluent water. Absolute PFAS concentration in water filtered using either of the modified biochar materials was well under 10 ng/L, and under 2 ng/L using the biochar modified according to FIG. 3. In contrast, water filtered using conventional biochar materials was measured as having a total PFAS concentration around 200 ng/L.

FIG. 10 contains data produced from measurements of experimental treatment of several water samples with higher total PFAS loads, e.g., initially between 35 and 45 mg/L. Filtration media that include the example modified biochar material modified according to FIG. 3 left less than 2% of the original PFAS concentration in the filtered effluent water, at an absolute concentration below 1 mg/L. Conventional biochar material, and the example biochar material modified according to FIG. 2, each left more than 20% of the original PFAS concentration in the filtered effluent water, with absolute PFAS concentrations between 7 and 12 mg/L.

In addition to the preceding, the following example embodiments fall within the scope of the present disclosure or appended claims. Any given Example below that refers to multiple preceding Examples shall be understood to refer to only those preceding Examples with which the given Example is not inconsistent, and to exclude implicitly those preceding Examples with which the given Example is inconsistent.

Example 1. A method for modifying biochar material, the method comprising: (A) within a first non-oxidizing atmosphere, heating a starting biochar material to a first temperature between 400° C. and 500° C., between 425° C. and 475° C., or at about 450° C., and maintaining the first non-oxidizing atmosphere and the first temperature for between 50 and 70 minutes, between 55 and 65 minutes, or 60 minutes, to form an intermediate biochar material; (B) after part (A), within a second non-oxidizing atmosphere, heating the intermediate biochar material to a second temperature greater than or equal to the first temperature, and maintaining the second non-oxidizing atmosphere and the second temperature for between 50 and 70 minutes, between 55 and 65 minutes, or 60 minutes; (C) after part (B), within a third non-oxidizing atmosphere, heating the intermediate biochar material to a third temperature between 750° C. and 1000° C., between 850° C. and 950° C., or at about 900° C., and maintaining the third non-oxidizing atmosphere and the third temperature for between 50 and 70 minutes, between 55 and 65 minutes, or 60 minutes; and (D) after part (C), within a fourth non-oxidizing atmosphere, cooling the intermediate biochar material to room temperature at a rate of cooling greater than any rate of heating employed in parts (A), (B), or (C) to produce the modified biochar material.

Example 2. The method of Example 1 wherein the cooling to room temperature of part (D) is carried out in less than 30 minutes, or less than 15 minutes.

Example 3. The method of any one of Examples 1 or 2 wherein the starting biochar material comprises material resulting from processing of manure, poultry litter, hemp stalk, mushrooms, or waste animal bones by slow pyrolysis, intermediate pyrolysis, fast pyrolysis, gasification, hydrothermal carbonization, or torrefaction.

Example 4. The method of any one of Examples 1 through 3 wherein the modified biochar material exhibits greater affinity for PFASs than does the starting biochar material.

Example 5. The method of any one of Examples 1 through 4 wherein the modified biochar material exhibits electrical conductivity greater than 4 dS/m and a molar H/C ratio less than 0.40.

Example 6. The method of Example 5 wherein the modified biochar material exhibits electrical conductivity greater than 5 dS/m or a molar H/C ratio less than 0.35.

Example 7. The method of any one of Examples 5 or 6 wherein the modified biochar material exhibits electrical conductivity greater than 6 dS/m or a molar H/C ratio less than 0.30.

Example 8. The method of any one of Examples 1 through 7 wherein: (i) the first, second, and third non-oxidizing atmospheres each consist essentially of CO₂; (ii) the first and second temperatures are about equal; and (iii) the fourth non-oxidizing atmosphere consists essentially of N₂ or a noble gas.

Example 9. The method of Example 8 wherein the starting biochar material is heated to the first temperature at a rate of heating between 15° C./min and 25° C./min, between 18° C./min and 22° C./min, or at about 20° C./min.

Example 10. The method of any one of Examples 1 through 7 wherein: (i) the first non-oxidizing atmosphere consists essentially of CO₂; (ii) the second and third non-oxidizing atmospheres each consist essentially of N₂; (iii) the second temperature is between 600° C. and 700° C., between 625° C. and 675° C., or at 650° C.; and (iv) the fourth non-oxidizing atmosphere consists essentially of N₂ or a noble gas.

Example 11. The method of Example 10 wherein: (i) the starting biochar material is heated to the first temperature at a rate of heating between 15° C./min and 25° C./min, between 18° C./min and 22° C./min, or at 20° C./min; and (ii) the intermediate biochar material is heated to the second temperature at a rate of heating between 15° C./min and 25° C./min, between 18° C./min and 22° C./min, or at 20° C./min.

Example 12. A composition of matter comprising a modified biochar material resulting from the method of any one of Examples 1 through 11.

Example 13. The composition of matter of Example 12 further comprising styrene-butadiene-styrene (SBS) granules embedded in an M-Class rubber (MCR) material, wherein particles of the modified biochar material are attached to the SBS granules.

Example 14. The composition of Example 13 wherein the particles of the modified biochar material are present at a proportion of between 20 and 28 percent of total weight of the particles of the modified biochar material, the SBS granules, and the MCR material.

Example 15. The composition of any one of Examples 13 or 14 wherein the MCR material is an ethylene propylene diene monomer (EPDM) material.

Example 16. The composition of any one of Examples 13 through 15, further comprising one or more of activated carbon, other conventional or modified biochar, wood chips or dust, nanoparticles attached to the SBS granules or embedded in the MCR material.

Example 17. A filter device for capturing hydrocarbons and PFASs entrained in a volume of water in a constrained flow, the device comprising a multitude of fractured fragments comprising particles of the modified biochar material of Example 12 attached to styrene-butadiene-styrene (SBS) granules embedded in an M-Class rubber (MCR) material to form the composition of any one of Examples 13 through 16, the fragments being supported between an inlet for influent water and a discharge outlet for effluent water.

Example 18. A filter device for comprising a multitude of fractured fragments comprising particles of a modified biochar material attached to styrene-butadiene-styrene (SBS) granules embedded in an M-Class rubber (MCR) material, the fragments being supported between an inlet for influent water and an outlet for effluent water.

Example 19. The filter device of any one of Examples 17 or 18 wherein the modified biochar material exhibits electrical conductivity greater than 4 dS/m and a molar H/C ratio less than 0.40.

Example 20. The filter device of Example 19 wherein the modified biochar material exhibits electrical conductivity greater than 5 dS/m or a molar H/C ratio less than 0.35.

Example 21. The filter device of any one of Examples 19 or 20 wherein the modified biochar material exhibits electrical conductivity greater than 6 dS/m or a molar H/C ratio less than 0.30.

Example 22. The filter device of any one of Examples 17 through 21, further comprising one or more of activated carbon, other conventional or modified biochar, wood chips or dust, nanoparticles attached to the SBS granules or embedded in the MCR material.

Example 23. The filter device of any one of Examples 17 through 22 wherein the fragments are deployed in a pipe.

Example 24. The filter device of any one of Examples 17 through 22 wherein the fragments are deployed in a filtration cartridge.

Example 25. The filter device of any one of Examples 17 through 22 wherein the fragments are disposed in a recess including an open top within the filter module.

Example 26. The filter device of any one of Examples 17 through 25 wherein the fractured fragments are between 1 and 2 centimeters.

Example 27. A method employing the filter device of any one of Examples 17 through 26, the method comprising directing an influent water stream into the inlet, through interstices of the multitude of the fractured fragments, and out of the outlet as an effluent water stream, and reducing or removing hydrocarbons and PFASs entrained in the influent water stream.

Example 28. The method of Example 27 wherein PFAS concentration of the effluent water stream is less than 20% of PFAS concentration of the influent water stream, or less than 10%, less than 5%, less than 2%, or less than 1%.

Example 29. The method of any one of Examples 27 or 28, wherein the fractured fragments further comprise one or more of activated carbon, an additional biochar material different from the modified biochar material, wood chips or dust, or nanoparticles attached to the SBS granules or embedded in the MCR material, the method further comprising reducing or removing one or more metals, one or more metal oxides, or one or more phosphates entrained in the influent water stream.

Example 30. A method for forming a solid material for filtering a volume of water, the method comprising: (a) forming a mixture of (i) particles of the modified biochar material of Example 12 attached to styrene-butadiene-styrene (SBS) granules and (ii) an M-Class rubber (MCR), by mixing particles of the modified biochar material, the SBS granules, and granules of the MCR; (b) feeding the mixture of part (a) through an extruder, and heating the mixture in the extruder to a temperature that melts the MCR granules but does not melt the SBS granules; and (c) extruding the heated mixture through a die.

Example 31. The method of Example 30 resulting in the composition of any one of Examples 13 through 16.

Example 32. The method of any one of Examples 30 or 31 further comprising, before part (a), forming the particles of the modified biochar material using the method of any one of Examples 1 through 11.

Example 33. The method of any one of Examples 30 through 32, wherein the mixture further includes one or more of activated carbon, an additional biochar material different from the modified biochar material, wood chips or dust, nanoparticles, that in the solid body are attached to the SBS granules or embedded in the MCR material.

Example 34. The method of any one of Examples 30 through 33 further comprising automatically cutting the mixture as it passes out of the die to form fragments that fracture as they cool.

Example 35. The method of any one of Examples 30 through 34 wherein part (b) comprises heating the mixture in the extruder to a temperature that is greater than 15° F. (8° C.) below an effective melting point of the MCR at the pressure in the extruder and less than 10° F. (6° C.) above the effective melting point of the MCR at the pressure in the extruder, and also less than an effective melting point of the SBS at the pressure in the extruder.

Example 36. The method of Example 35 wherein heating the mixture in the extruder comprises heating the mixture by setting the extruder to a temperature of between 49° C. and 54° C.

This disclosure is illustrative and not limiting. Further modifications will be apparent to one skilled in the art in light of this disclosure and are intended to fall within the scope of the present disclosure. It is intended that equivalents of the disclosed example embodiments and methods, or modifications thereof, shall fall within the scope of the present disclosure.

In the foregoing Detailed Description, including the drawings, various features may be grouped together in several example embodiments for the purpose of streamlining the disclosure. This method of disclosure is not to be interpreted as reflecting an intention that any embodiment requires more features than are expressly recited or that any recited feature or features are necessary. Rather, inventive subject matter may lie in less than all features of a single disclosed example embodiment. The present disclosure includes any and all combinations of features disclosed herein. Therefore, the present disclosure shall be construed as disclosing any embodiment having any suitable subset of one or more features shown or described in the present disclosure-including those subsets that may not be separately discussed herein in that specific combination. A “suitable” subset of features includes only features that are neither incompatible nor mutually exclusive with respect to any other feature of that subset.

The following interpretations shall apply. Unless otherwise specified, all words used herein carry their common meaning as understood by a person having ordinary skill in the art. The words “comprising,” “including,” “having,” and variants thereof, wherever they appear, shall be construed as open-ended terminology, with the same meaning as if a phrase such as “at least” were appended after each instance thereof, unless explicitly stated otherwise. The article “a” shall be interpreted as “one or more” unless “only one,” “a single,” or other similar limitation is stated explicitly or is implicit in the particular context; similarly, the article “the” shall be interpreted as “one or more of the” unless “only one of the,” “a single one of the,” or other similar limitation is stated explicitly or is necessary in the particular context. The conjunction “or” is to be construed inclusively unless: (i) it is explicitly stated otherwise, e.g., by use of “either . . . or,” “only one of,” or similar language; or (ii) two or more of the listed alternatives are understood or disclosed (necessarily or explicitly) to be incompatible or mutually exclusive within the particular context. In that latter case, “or” would be understood to encompass only those combinations involving non-mutually-exclusive alternatives. In one example, each of “a dog or a cat,” “one or more of a dog or a cat,” and “one or more dogs or cats” would be interpreted as one or more dogs without any cats, or one or more cats without any dogs, or one or more of each.

Moreover, when a numerical quantity is recited (with or without terms such as “about,” “about equal to,” “substantially equal to,” “greater than about,” “less than about,” and so forth), standard conventions pertaining to measurement precision, rounding error, and significant digits shall apply, unless a differing interpretation is explicitly set forth, or if a differing interpretation is inherent (e.g., some small integer quantities). For null quantities described by phrases such as “equal to zero,” “absent,” “eliminated,” “negligible,” “prevented,” and so forth (with or without terms such as “about,” “substantially,” and so forth), each such phrase shall denote the case wherein the quantity in question has been reduced or diminished to such an extent that, for practical purposes in the context of the intended operation or use of the disclosed apparatus or method, the overall behavior or performance of the apparatus or method does not differ from that which would have occurred had the null quantity in fact been completely removed, exactly equal to zero, or otherwise exactly nulled. Terms such as “parallel,” “perpendicular,” “orthogonal,” “flush,” “aligned,” and so forth shall be similarly interpreted (with or without terms such as “about,” “substantially,” and so forth).

Further, any labelling of elements, steps, limitations, or other portions (e.g., first, second, third, etc., (a), (b), (c), etc., or (i), (ii), (iii), etc.) is only for purposes of clarity, and shall not be construed as implying any sort of ordering or precedence of the portions so labelled. If any such ordering or precedence is intended, it will be explicitly recited or, in some instances, it will be inherent. Absent use of the word “means” or the phrase “step for” in a claim, invocation of provisions of law relating to “means/function” or “step/function” is not intended.

The Abstract is provided as required as an aid to those searching for specific subject matter within the patent literature. However, the Abstract is not intended to imply that any elements, features, or limitations recited therein are necessary.

What is claimed is:

1. A method for modifying a biochar material, the method comprising:
(A) within a first non-oxidizing atmosphere, heating a starting biochar material to a first temperature between 400° C. and 500° C., and maintaining the first non-oxidizing atmosphere and the first temperature for between 50 and 70 minutes, to form an intermediate biochar material;
(B) after part (A), within a second non-oxidizing atmosphere, heating the intermediate biochar material to a second temperature greater than or equal to the first temperature, and maintaining the second non-oxidizing atmosphere and the second temperature for between 50 and 70 minutes;
(C) after part (B), within a third non-oxidizing atmosphere, heating the intermediate biochar material to a third temperature between 750° C. and 1000° C., and maintaining the third non-oxidizing atmosphere and the third temperature for between 50 and 70 minutes; and
(D) after part (C), within a fourth non-oxidizing atmosphere, cooling the intermediate biochar material to room temperature at a rate of cooling greater than any rate of heating employed in parts (A), (B), or (C) to produce modified biochar material.

2. The method of claim 1 wherein the cooling to room temperature of part (D) is carried out in less than 30 minutes.

3. The method of claim 1 wherein the starting biochar material comprises material resulting from processing of manure, poultry litter, hemp stalk, mushrooms, or waste animal bones by slow pyrolysis, intermediate pyrolysis, fast pyrolysis, gasification, hydrothermal carbonization, or torrefaction.

4. The method of claim 1 wherein the modified biochar material exhibits greater affinity for PFASs than does the starting biochar material.

5. The method of claim 1 wherein the modified biochar material exhibits electrical conductivity greater than 4 dS/m and a molar H/C ratio less than 0.40.

6. The method of claim 1 wherein: (i) the first, second, and third non-oxidizing atmospheres each consist essentially of CO₂; (ii) the first and second temperatures are about equal; and (iii) the fourth non-oxidizing atmosphere consists essentially of N₂ or a noble gas.

7. The method of claim 6 wherein the starting biochar material is heated to the first temperature at a rate of heating between 15° C./min and 25° C./min.

8. The method of claim 1 wherein: (i) the first non-oxidizing atmosphere consists essentially of CO₂; (ii) the second and third non-oxidizing atmospheres each consist essentially of N₂; (iii) the second temperature is between 600° C. and 700° C.; and (iv) the fourth non-oxidizing atmosphere consists essentially of N₂ or a noble gas.

9. The method of claim 8 wherein: (i) the starting biochar material is heated to the first temperature at a rate of heating between 15° C./min and 25° C./min; and (ii) the intermediate biochar material is heated to the second temperature at a rate of heating between 15° C./min and 25° C./min.

10. A composition of matter comprising a modified biochar material resulting from a process that comprises:
(A) within a first non-oxidizing atmosphere, heating a starting biochar material to a first temperature between 400° C. and 500° C., and maintaining the first non-oxidizing atmosphere and the first temperature for between 50 and 70 minutes, to form an intermediate biochar material;
(B) after part (A), within a second non-oxidizing atmosphere, heating the intermediate biochar material to a second temperature greater than or equal to the first temperature, and maintaining the second non-oxidizing atmosphere and the second temperature for between 50 and 70 minutes;
(C) after part (B), within a third non-oxidizing atmosphere, heating the intermediate biochar material to a third temperature between 800° C. and 1000° C., and maintaining the third non-oxidizing atmosphere and the third temperature for between 50 and 70 minutes; and
(D) after part (C), within a fourth non-oxidizing atmosphere, cooling the intermediate biochar material to room temperature at a rate of cooling greater than any rate of heating employed in parts (A), (B), or (C) to produce the modified biochar material.

11. The composition of claim 10 wherein the modified biochar material exhibits electrical conductivity greater than 4 dS/m and a molar H/C ratio less than 0.40.

12. The composition of matter of claim 10 further comprising styrene-butadiene-styrene (SBS) granules embedded in an M-Class rubber (MCR) material, wherein particles of the modified biochar material are attached to the SBS granules.

13. The composition of claim 12 wherein the particles of the modified biochar material are present at a proportion of between 20 and 28 percent of total weight of the particles of the modified biochar material, the SBS granules, and the MCR material.

14. The composition of claim 12 wherein the MCR material is an ethylene propylene diene monomer (EPDM) material.

15. A filter device comprising a multitude of fractured fragments comprising particles of a modified biochar material attached to styrene-butadiene-styrene (SBS) granules embedded in an M-Class rubber (MCR) material, the fragments being supported between an inlet for influent water and an outlet for effluent water, wherein the modified biochar material exhibits electrical conductivity greater than 4 dS/m and a molar H/C ratio less than 0.4.

16. The filter device of claim 15 wherein the modified biochar material results from a process comprising:
(A) within a first non-oxidizing atmosphere, heating a starting biochar material to a first temperature between 400° C. and 500° C., and maintaining the first non-oxidizing atmosphere and the first temperature for between 50 and 70 minutes, to form an intermediate biochar material;
(B) after part (A), within a second non-oxidizing atmosphere, heating the intermediate biochar material to a second temperature greater than or equal to the first temperature, and maintaining the second non-oxidizing atmosphere and the second temperature for between 50 and 70 minutes;
(C) after part (B), within a third non-oxidizing atmosphere, heating the intermediate biochar material to a third temperature between 750° C. and 1000° C., and maintaining the third non-oxidizing atmosphere and the third temperature for between 50 and 70 minutes; and
(D) after part (C), within a fourth non-oxidizing atmosphere, cooling the intermediate biochar material to room temperature at a rate of cooling greater than any rate of heating employed in parts (A), (B), or (C) to produce the modified biochar material.

17. The filter device of claim 15 wherein: (i) the fragments are deployed in a pipe; (ii) the fragments are deployed in a filtration cartridge; or (iii) the fragments are disposed in a recess including an open top within the filter module.

18. The filter device of claim 15 wherein the fractured fragments are between 1 and 2 centimeters.

19. A filtering method comprising directing an influent water stream into an inlet of a filter device, through interstices of a multitude of fractured fragments of the filter device, and out of an outlet of the filter device as an effluent water stream, and removing or reducing hydrocarbons and PFASs entrained in the influent water stream, wherein:
the filter device comprises a multitude of fractured fragments comprising particles of a modified biochar material attached to styrene-butadiene-styrene (SBS) granules embedded in an M-Class rubber (MCR) material, the fragments being supported between the inlet and discharge outlets; and
the modified biochar material exhibits electrical conductivity greater than 4 dS/m and a molar H/C ratio less than 0.40.

20. The method of claim 19 wherein PFAS concentration of the effluent water stream is less than 2% of PFAS concentration of the influent water stream.

21. The method of claim 19 wherein the fractured fragments further comprise one or more of activated carbon, an additional biochar material different from the modified biochar material, wood chips or dust, or nanoparticles, the method further comprising reducing or removing one or more metals, one or more metal oxides, or one or more phosphates entrained in the influent water stream.

22. The method of claim 19 wherein the modified biochar material results from a process that comprises:
(A) within a first non-oxidizing atmosphere, heating a starting biochar material to a first temperature between 400° C. and 500° C., and maintaining the first non-oxidizing atmosphere and the first temperature for between 50 and 70 minutes, to form an intermediate biochar material;
(B) after part (A), within a second non-oxidizing atmosphere, heating the intermediate biochar material to a second temperature greater than or equal to the first temperature, and maintaining the second non-oxidizing atmosphere and the second temperature for between 50 and 70 minutes;
(C) after part (B), within a third non-oxidizing atmosphere, heating the intermediate biochar material to a third temperature between 750° C. and 1000° C., and maintaining the third non-oxidizing atmosphere and the third temperature for between 50 and 70 minutes; and
(D) after part (C), within a fourth non-oxidizing atmosphere, cooling the intermediate biochar material to room temperature at a rate of cooling greater than any rate of heating employed in parts (A), (B), or (C) to produce the modified biochar material.

23. The method of claim 19 wherein the modified biochar material exhibits greater affinity for PFASs than does the starting biochar material.

24. A method for forming a solid material for filtering a volume of water, the method comprising:
(a) forming a mixture of (i) particles of a modified biochar material attached to styrene-butadiene-styrene (SBS) granules and (ii) an M-Class rubber (MCR), by mixing particles of the modified biochar material, the SBS granules, and granules of the MCR;
(b) feeding the mixture of part (a) through an extruder, and heating the mixture in the extruder to a temperature that melts the MCR granules but does not melt the SBS granules; and
(c) extruding the heated mixture through a die,
wherein the modified biochar material exhibits electrical conductivity greater than 4 dS/m and a molar H/C ratio less than 0.40.

25. The method of claim 24 wherein the modified biochar material results from a process comprising:
(A) within a first non-oxidizing atmosphere, heating a starting biochar material to a first temperature between 400° C. and 500° C., and maintaining the first non-oxidizing atmosphere and the first temperature for between 50 and 70 minutes, to form an intermediate biochar material;
(B) after part (A), within a second non-oxidizing atmosphere, heating the intermediate biochar material to a second temperature greater than or equal to the first temperature, and maintaining the second non-oxidizing atmosphere and the second temperature for between 50 and 70 minutes;
(C) after part (B), within a third non-oxidizing atmosphere, heating the intermediate biochar material to a third temperature between 750° C. and 1000° C., and maintaining the third non-oxidizing atmosphere and the third temperature for between 50 and 70 minutes; and
(D) after part (C), within a fourth non-oxidizing atmosphere, cooling the intermediate biochar material to room temperature at a rate of cooling greater than any rate of heating employed in parts (A), (B), or (C) to produce the modified biochar material.

26. The method of claim 24 further comprising, before part (a), forming the particles of the modified biochar material.

27. The method of claim 24 further comprising automatically cutting the mixture as it passes out of the die to form fragments that fracture as they cool.

28. The method of claim 24 wherein part (b) comprises heating the mixture in the extruder to a temperature that is greater than 15° F. (8° C.) below an effective melting point of the MCR at the pressure in the extruder and less than 10° F. (6° C.) above the effective melting point of the MCR at the pressure in the extruder, and also less than an effective melting point of the SBS at the pressure in the extruder.

29. The method of claim 28 wherein heating the mixture in the extruder comprises heating the mixture by setting the extruder to a temperature of between 49° C. and 54° C.
